(19) United States
(12) Patent Application Publication
(10) Pub. No.: US 2009/0195510 A1
(43) Pub. Date: Aug. 6, 2009

(54) ERGONOMIC USER INTERFACE FOR HAND HELD DEVICES

(76) Inventor: Samuel F. SAUNDERS, Lovingston, VA (US)

Correspondence Address: MCGUIREWOODS, LLP, 1750 TYSONS BLVD, SUITE 1800, MCLEAN, VA, 22102, US

(21) Appl. No.: 12/364,263

(22) Filed: Feb. 2, 2009

Related U.S. Application Data
(60) Provisional application No. 61/025,496, filed on Feb. 1, 2008.
(60) Provisional application No. 61/038,182, filed on Mar. 20, 2008.

(51) Int. Cl. G06F 3/02; G06F 3/00; G06F 3/041

(52) U.S. Cl. 345/169; 715/765; 345/173

(57) ABSTRACT

A user interface for a hand held electronic device, such as a cell phone, provides multiple touch sensate feature functions. In one embodiment, the user interface may include a plurality of touch sensitive keys arranged contiguously with an outermost first subset of the plurality of touch sensitive keys symmetrically forming four corners of a substantially rectangular touch pad, a second subset of the keys arranged circularly within the outermost first subset of the plurality of touch sensitive keys, and a third subset of the plurality of touch sensitive keys arranged symmetrically within the second subset of the plurality of touch sensitive keys, wherein each of the plurality of touch sensitive keys is configured to receive user input to operate at least one feature associated with the hand held electronic device. Moreover, the second subset of the plurality of touch sensitive keys may comprise twelve keys and may be configured to mimic an analog clock layout, with each of the twelve keys representing corresponding telephonic dial pad digits, 1-9, 0, *, #, respectively. The touch sensitive key area may be overlayed with a display function, e.g., a LCD.

### CROSS REFERENCE TO RELATED APPLICATIONS

This application claims benefit of and priority to U.S. Provisional application No. 61/025,496 filed Feb. 1, 2008, and also claims benefit and priority to U.S. Provisional application No. 61/038,182 filed Mar. 20, 2008, the disclosures of which are incorporated by reference herein in their entirety.

### BACKGROUND OF THE INVENTION

1.0 Field of Invention

The invention relates generally to an interface for a hand held device, and more particularly, to an interface for a hand held device that permits an intuitive layout and visual feedback and for better control by a user's hand, fingers, thumb, or stylus.

2.0 Related Art

Current electronic hand held devices such as cell phones, personal digital assistants, iPod®, Blackberry®, television remote controller, and the like, mostly employ a traditional user interface so that control of the hand held device is accomplished by way of multiple buttons and keys. If the hand held device also provides for telephonic dialing, the device typically includes a traditional layout of a key pad in rows and columns, usually arranged in a 3×4 matrix.

However, the user interface is typically laid out so that the user must usually locate proper key depressions by looking at the face of the device (unless quite familiar with the layout), and the layout may not be very intuitive. Furthermore, the keys or controls employed are typically multiple individual keys, most of which usually having fixed functions without dynamic operational characteristics.

Additionally, none of the devices found on the marketplace today offer any feedback before a key is depressed, therefore making the keypad and not the screen itself a more important part of the device. This lack of technology requires an up, down flicking of the eyes and head as you first search out the key, depress it, and then, focus on the screen to make sure that the intended key was actually pushed.

### SUMMARY OF THE INVENTION

With the aforementioned problems in mind, a new user interface for hand held electronic devices, and the like, is provided. As various user interfaces in a wide range of industries gravitates more toward touch screen technology, the user of such devices is losing more and more of the “touch and feel” of their hand held device and are being required to operate their device with two hands, paying careful attention to each “keystroke,” etc. The user interface device configured according to principles of the invention takes an approach that deals with real world application whereby a user may not always be able to use both hands, requiring that they stop, focus on keypad, press a key, verify key pressed on a display, focus on location of next key, press a key, verify key pressed on a display, etc.

Additionally, the user interface device configured according to principles of the invention may provide feedback before a key is depressed to provide information related to the function being considered based on a current position of a user digit, or a stylus. This substantially avoids a need for a down flicking of the eyes and head as a user searches out the proper key for an intended function, depresses it, and focuses on the screen to make sure that the intended key was actually pushed.

In one aspect, the user interface includes a user interface for a hand held electronic device including a plurality of touch sensitive keys arranged contiguously with an outermost first subset of the plurality of touch sensitive keys symmetrically forming four corners of a substantially rectangular touch pad, a second subset of the keys arranged circularly within the outermost first subset of the plurality of touch sensitive keys, and a third subset of the plurality of touch sensitive keys arranged symmetrically within the second subset of the plurality of touch sensitive keys, wherein each of the plurality of touch sensitive keys is configured to receive user input to operate at least one feature associated with the hand held electronic device.

In another aspect, a user interface for a hand held electronic device is provided and includes a plurality of touch sensitive keys arranged contiguously with an outermost first subset of the plurality of touch sensitive keys symmetrically forming four corners of a substantially rectangular touch pad, a second subset of the keys arranged circularly within the outermost first subset of the plurality of touch sensitive keys, and a third subset of the plurality of touch sensitive keys arranged symmetrically within the second subset of the plurality of touch sensitive keys, and a fourth subset of the plurality of touch sensitive keys located within the third subset of the plurality of touch sensitive keys, wherein each of the plurality of touch sensitive keys is configured to receive user input to operate at least one feature associated with the hand held electronic device and wherein the plurality of touch sensitive keys comprises a monolithic pad and each subset of keys is delineated from another subset by a tactile feature to distinguish each subset from another.

In yet another aspect, a method for providing a user interface is provided including providing at least one circular thumb guide configured with at least one rim for guiding a digit of a user or a stylus, configuring a plurality of keys on a touch sensitive surface, wherein the plurality of keys configured to have indicia dynamically assigned, and wherein the at least one circular thumb guide is configured on at least a subset of the plurality of keys, providing electronics to determine a position of the digit of a user or stylus in relation to the plurality of keys and processing a feature based on the determined position.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1A is a top view of an embodiment of a user interface (tracr) showing the input section, according to principles of the invention;

FIG. 1B is a top view of tracr of FIG. 1A, showing exemplary key arrangement, according to principles of the invention;

FIG. 2 is cross-section view of tracr showing tactile contours, according to principles of the invention;

FIG. 3 is an elevation view of an exemplary device for employing the tracr, according to principles of the invention; and

FIG. 4 is a block diagram of an exemplary kickstand of the embodiment of FIG. 3, according to principles of the invention;

FIGS. 5A, 5B, 5C and 5D are illustrations of an embodiment of a user interface, constructed according to principles of the invention;

FIGS. 6A, 6B, 6C and 6D are illustrations of the user interface of FIGS. 5A-5D showing certain exemplary relative dimensional information of the tactile delineators and certain keys;

FIG. 7A is an illustration of an embodiment of a user interface configured according to principles of the invention;

FIG. 7B is an illustration of an embodiment of a user interface configured according to principles of the invention;

FIG. 8, is an illustration of an embodiment of the user interface configured according to principles of the invention and displaying a dial list; and

FIGS. 9, 10, 11, 12 and 13 are each embodiments of a user interface configured according to principles of the invention;

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings, although not every figure may repeat each and every feature that has been shown in another figure in order to not obscure certain features or overwhelm the figure with repetitive indicia.

It is understood that the invention is not limited to the particular methodology, protocols, devices, apparatuses, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention. The term thumb guide broadly includes a feature or structure configured for guiding a digit of a user hand, particularly a thumb.

The user interface as provided in different embodiments and configured according to principles of the invention is referenced herein generally as “tracr.” To simplify the description herein, the user interface is described in reference to a cell phone application, but it should be understood that the user interface of the invention may be used in nearly any electronic hand held device, such as, for example, remote control devices, personal digital assistants, or similar related applications. The user interface configured according to principles of the invention provides for a tactilely and intuitively arranged surface so that a user may control the electronic device that employs the user interface, which is different from user interfaces commonly found in many electronic hand held devices in use prior to the invention, and as described more below.

When the user interface configured according to principles of the invention is employed in a mobile phone device, for example, the user interface may reduce multiple, alternate key selections to one central, tactile, touch screen keypad. In effect, the user may be able to make most of their selections on the device by never leaving this circular keypad. One of several features provided by tracr is offer a better, more realistic solution for certain cross sections of the world's population who may be frustrated with their current device's keypad and/or require a device that is more flexible in regards to motion. Tracr provides an efficient, user friendly and perhaps the least misdialed user interface for a cell phone on the marketplace.

Several features of tracr in one or more embodiments may include:
Embossed Keypad—focuses the thumb or driver finger on one particular area, the working area, of the device in an ergonomic circular dial, thereby eliminating the need for the user to move from this area for most applications.
Resistant Touch Screen—plots exact X-Y coordinate of each keystroke in relation to the entire keypad so that even if you depress only 51% of the “correct” key, the correct character or utility is deployed.
Touch Screen—may allow the unit to dynamically change based on the utility deployed.
Pressure Sensitive—may allow a user to rest their finger, glove or fingernail on the unit and see their selection before it is even selected (“Resting” technology).
Individual Keys—may give a user both an audible and tactile feedback as they progress around the dial as well as a tactile feedback once a key is actually depressed.
Large Keys—may give the user a large 3-D surface area to use as they navigate and make selections.

Furthermore, in multiple features, tracr may aid a user who may be “on the go” with software that offers efficient solutions to a number of real time situations. All of these solutions allow the user to quickly and efficiently use the circular setup of tracr's hardware and its touch screen capabilities to deal with calls, text messages, collect phone numbers from the office and many other utilities that are cumbersome or non-existent on current models.

The face of tracr (i.e., outer visual surface) may be broken down for reference purposes into a number of terms associated with the device's layout. From a macro standpoint, most cell phones typically include two main areas—the input section commonly located on the lower side (“bottom half”) of the device, and the output section (i.e., display) is commonly located on the upper side (“upper half”) of the device. It should be understood that this may be one continuous screen thereby permitting the user to input data from a non-keypad area (often configured at the top of the device, such as the upper half), and may be referred to as the screen or display area; and the continuous screen may include the keypad or keypad area (often configured at the bottom of the device, such as the bottom half).

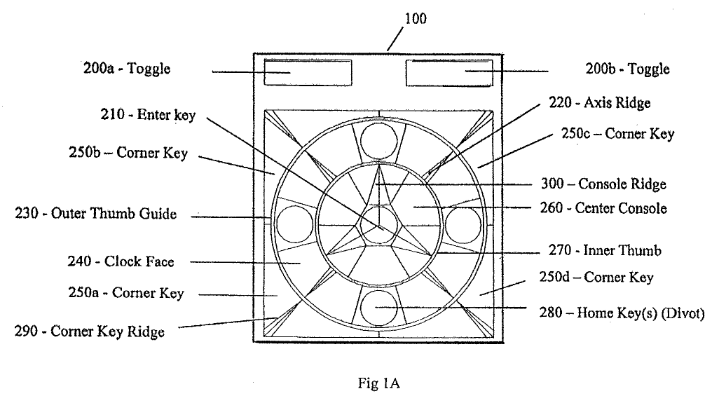

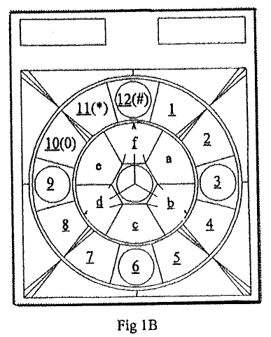

FIG. 1 is a top view of an embodiment of tracr showing an input section, according to principles of the invention. The input section is shown as part of a hand held device 100 to encompass the tracr user input section. All of tracr's input comes from a touch screen input pad (e.g., a non-displaying touch sensitive panel with or without indicia, a touch sensitive pad or surface such as a touch sensitive LCD panel, or similar touch sensitive panel)—that is to say, the actual utility of a key dynamically changes according to the function that is selected by a user. The touch screen input pad is preferably a monolithic pad with the keys formed by the tactile delineations, and readable as individual keys by the associated electronics. However, alternatively, the pad may comprise a plurality of touch sensitive pads closely coupled to mimic a monolithic pad.

Unlike typical touch screen applications (i.e., prior to the invention), tracr's keys actually may “click” which gives the user physical feedback as a key is depressed. Moreover, the touch screen panel may have physical tactile characteristics that may include raised or lowered ridges and/or dimples to facilitate quick and easy identification of locations on the input section touch screen panel, as describe more below. The names given to each of the “keys” herein (for all embodiments) are exemplary to the application described, and are not meant to limit any key to any particular feature or function in any way. For other applications in different devices, the various keys may take on other names and functions. Each key is readable by electronics (typically a microprocessor and memory and supporting hardware) of the hand held device coupled to the tracr touch screen panel. The electronics coordinate the key input to features provided by or through the application of the hand held device 100, perhaps in conjunction with a service remotely in communication with the hand held device.

The input section of tracr as depicted in FIG. 1 generally comprises five regions:

1) An outermost extreme portion comprising four “corner keys” 250a-d configured on the outermost opposing diagonal portions of the tracr face. These keys may be designated for main categories of features, or flexibly configured for any types of functions associated with overall operations of the hand held device, for example;

2) An outer region 240 may be configured in a circular clock face pattern having multiple “key” locations (such as twelve keys as shown), perhaps simulating the layout of a common analog type clock, wherein the twelve “keys” are located substantially where the hour positions would be found on an analog clock. Referring to FIG. 1B for the “clock-like” layout of the outer region, reference numerals 1-12 indicate locations of the exemplary twelve “keys.” The outer region 240 may be delineated from the outermost extreme portions 250 by an outer thumb guide 230. The thumb guide 230 may comprise a raised ridge (or, alternatively, a “lowered” valley) for tactile location orientation. The keys at the 3, 6, 9 and 12 positions have a dimple for another form of tactile feedback to aid easier location and identification of these keys in relation to other keys on the face of tracr;

3) An innermost region generically called the “enter key” 210;

4) A region between the counter region 240 (i.e., the “clock face”) and the enter key 210 is typically called the “center console” 260 and may comprise multiple keys such as six keys (denoted as keys a-f in FIG. 1B). The center console six keys a-f may also have raised tactile ridges (or valleys) as shown in relation to keys b, d, and f, perhaps seen better in FIG. 1. Any of the keys a-f may have tactile ridges (or valleys); and

5) An upper region above the “corner keys” 250b and 250c comprise “toggle” keys 200a, 200b.

The corner keys 250a-d may be located on the outermost portion adjacent the “clock face” 240, in all four corners. Two sides of each “corner key” 250 may be square with perpendicular edges, while the third side is substantially rounded since it is configured to “sit” against the round “clock face” 240. The upper two “corner keys” 250b and 250c are located just beneath the “toggle keys” 200a-b. Each corner key 250a-d may have a raised ridge (or alternatively a lowered valley) area (about 1/16″ in height) in the center called the corner ridge (290). An axis ridge 220 may be employed on the four corner locations as an added tactile feature on the keys shown.

The outer region, or “clock face” 240 is generally round in nature and takes its name based on its close resemblance to its namesake. However, when considering and supporting a telephonic operation, the twelve keys typically available in telephony dialing operations are positioned substantially with an analog type clock in mind. That is, each telephony key (commonly found on most telephones that have a 3×4 dialing pad) from 1 to 9 is “exactly” where the corresponding number would appear on a typical and historic analog clock. The “0” key, the star (*) key and the pound sign (#) are situated in the 10, 11 and 12 o'clock positions respectively, as shown. The location of the keys 1-12 of the “clock face” 240 and their close association with a standard type analog clock face greatly decreases the learning curve to the user. Moreover, the human mind tends to image the clock layout fairly well. Furthermore, be it understood that the device may be manipulated without looking, due to the intuitively positioned keys and an advanced keypad that has more “touch and feel” (i.e., the various tactile characteristics such as ridges and dimples) than any device available today.

At the 3, 6 and 9 and 12 o'clock positions of the clock face 240, called the “home keys” 280, the surface at these locations has slight indentions or divots (typically circular in shape) to distinguish them from any other key on the “clock face.” Alternatively, the divots may be convex “humps.” By way of an example, as the user runs their finger from the 12 to the 1 o'clock position, they go from the divot to a flat key, which is easily felt. This flat key is the “1” key, for telephonic operations. As you continue from the 1 to the 2 o'clock position, the user will cross a slight bump called the “axis ridge.” This axis ridge separates the “1” key from the “2” key, the “4” key from the “5” key, the “7” key from the “8” key and the “0” key from the “*” key. Again, as you continue in a clockwise manner from 2 to 3 o'clock, the key is flat and then transitions to a divot key at the 3 position. This pattern repeats around the entire “clock face” 240. It should be noted that the entire clock face 240 may be slightly concave (approximately 1/16″) and configured with two ridges (an inner thumb guide 270 and an outer thumb guide 230) circumferentially to guide the user's finger in a circular pattern. (Of course, any finger may be guided and not just a thumb.)

The inner region or the “enter key” 210 may be a hexagonal button in the center of the input section of the device. This “enter key” 210, like the “home keys” may have a distinguishing tactile marker such as a divot, which also set it apart by touch from the “center console” 260.

The “center console” 260 is generally the region between the “clock face” 240 and the “enter key” 210 and, in the preferred embodiment, comprises six keys a-f, although other number of keys may be configured. These keys a-f may typically be irregular hexagons, but may vary in some embodiments. Three of these keys (e.g., b, d, and f) may have a tactile characteristic such as a raised ridge called the console ridge 300 to distinguish them one from the other center console keys a, c and e.

The “toggle keys” 200a, 200b may be two keys found above the top two “corner keys” 250b and 250c. These two keys may be raised (approximately 1/16″), rectangular in shape and, like all keys on tracr, make a distinctive “click” when depressed. However, these keys may take on different shapes and different tactile characteristics, as appropriate to an application.

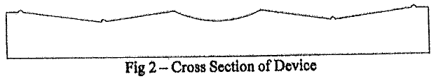

FIG. 2 is cross-section view of tracr showing tactile contours, according to principles of the invention. For example, if a user were to run a finger “east to west” (or from one side to the other), on the device surface, the following tactile features may be felt (dimensions herein are exemplary and may vary somewhat):
1. Panel encompassing device—start at 0″ in height.
2. A ridge on the corner key—up 1/32″ (net 1/32″).
3. A slight ridge on the outside of the “clock face” called the “outer thumb guide”—up 1/16″ (net 3/32″).
4. Ridge comes down 1/32″ to the “clock face” (net 1/16″).
5. The “clock face” keys fall about 1/16″ from the outer thumb guide to the inner thumb guide (net 0″).
6. A slight ridge after the “clock face” called the inner thumb guide—up 1/16″ (net 1/16″).
7. Ridge comes down 1/32″ to the center console (net 1/32″).
8. The center console rises as the finger approaches the “enter key”—up 1/32″ (net 1/16″).
9. The “enter key” comprises a divot—down 1/16″ (net 0″).

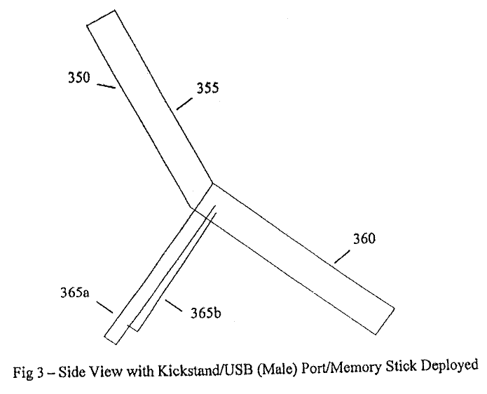

FIG. 3 is an elevation view of an exemplary device for employing the user interface (tracr), according to principles of the invention. The device 350 such as for a cell phone, or any other electronic hand holdable device, comprises an upper 355 and a lower portion 360. The tracr user interface may be a part of the lower portion 360, while the upper portion 355 may comprise a display, for example, to convey features to a user in coordination with the tracr key selections by a user, as appropriate to the application being supported.

In order to also facilitate hands-free usage, in some embodiments herein, data transfer/storage and a clear reception tracr may be equipped with kickstands 365a, 365b that extend outward behind the device 350. Once extended, the device 350 may sit comfortably on a flat surface and give both a hands-free and clear view of the screen (upper portion) and the clock-face.

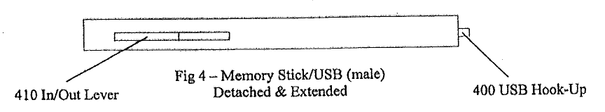

FIG. 4 is a block diagram of an exemplary kickstand of the embodiment of FIG. 3, according to principles of the invention. In this embodiment, the right leg 365b (for example) may have a memory chip and a male USB or similar media storage hookup, port 400 embedded inside while the left leg 365a may include the device's antenna (not shown), for example. By depressing a release located on the right leg 365b, this side may be removed from tracr and may be hooked up to any USB port by sliding the In/Out Lever 410, allowing data exchange from another device or from a PC/Mac personal computer or network. This data might be songs, contacts, voice data, games or any other information that one may desire to be saved or transferred to another device. Tracr's USB port (e.g., female connector) may be located beneath the right leg 365b and may only be exposed when the leg is extended. Furthermore, the kickstand itself can be used as a belt-clip thereby facilitating storage when not in use.

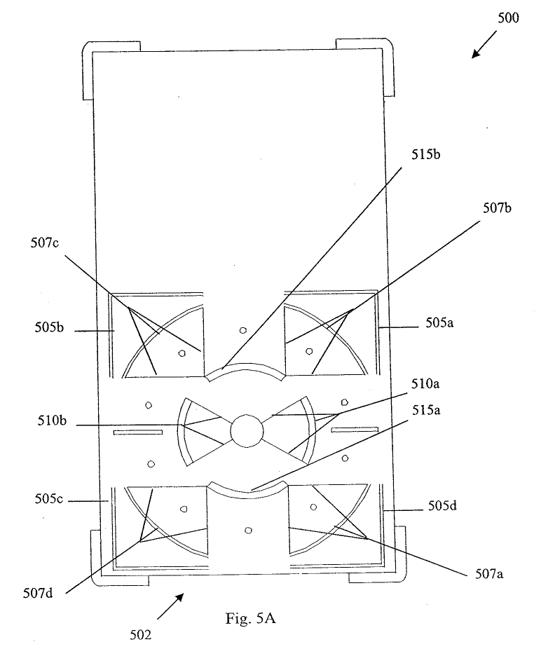

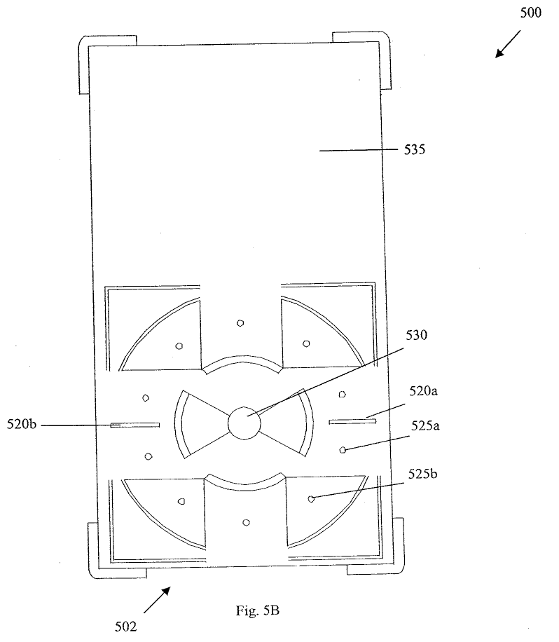

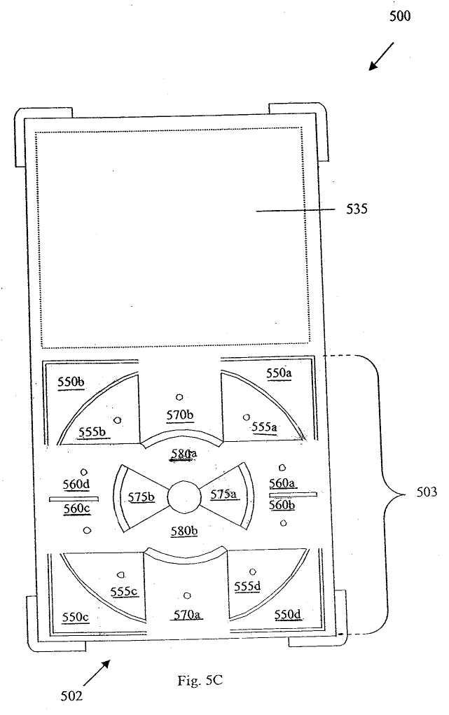

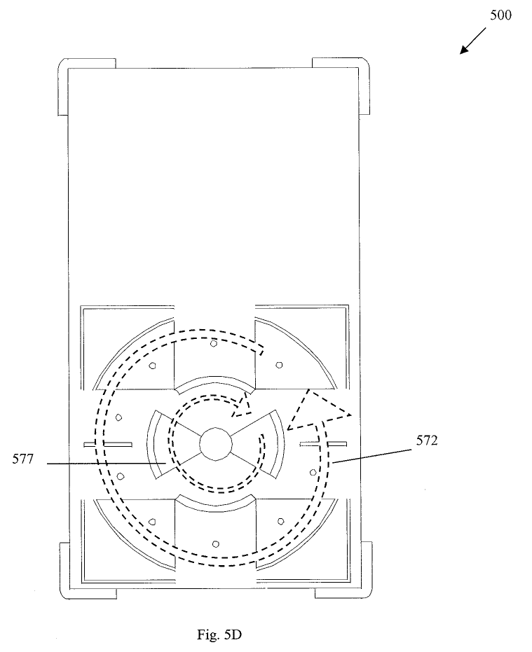

FIGS. 5A-5D are illustrations of an embodiment of a user interface, constructed according to principles of the invention, generally denoted by reference numeral 500. A touch sensitive screen 502 (e.g., a resistive type touch sensitive screen and/or a capacitive type touch screen) may be configured with various tactile delineators 505a-d, 507a-507d, 510a, 510b, 515a, 515b, 520a, 520b that may be embossed, for example, in the surface of the touch sensitive screen 502 and may form the border contours of various “keys” (e.g., 550a-550d, 555a-555d, 560a-560d, 570a, 570b, 575a, 575b, 580a, 580b) and/or one or more thumb-guides 570, 575. The tactile delineators may be raised ridges or may be lowered depressions, and may be transparent, translucent, or in some embodiments, a more solid coloration. The various “keys” 550a-550d, 555a-555d, 560a-560d, 570a, 570b, 575a, 575b, 580a, 580b may be touch sensitive pre-designated designated areas of the keypad area 503

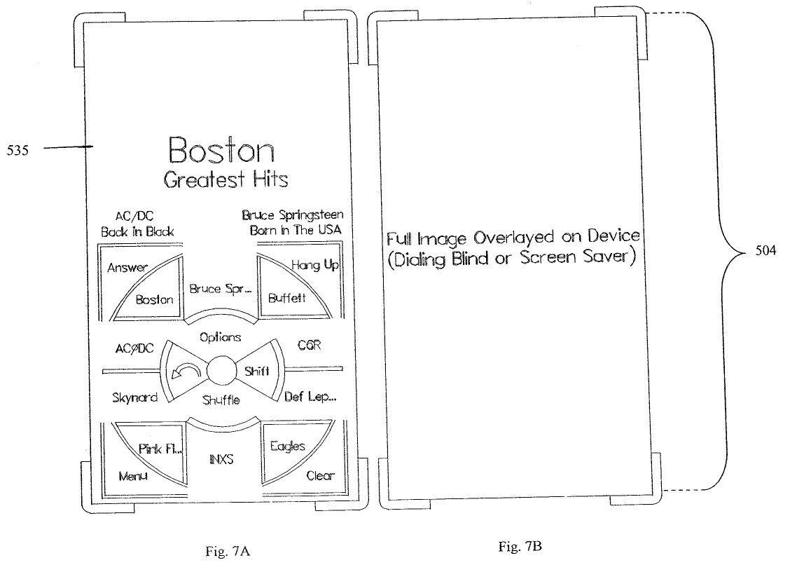

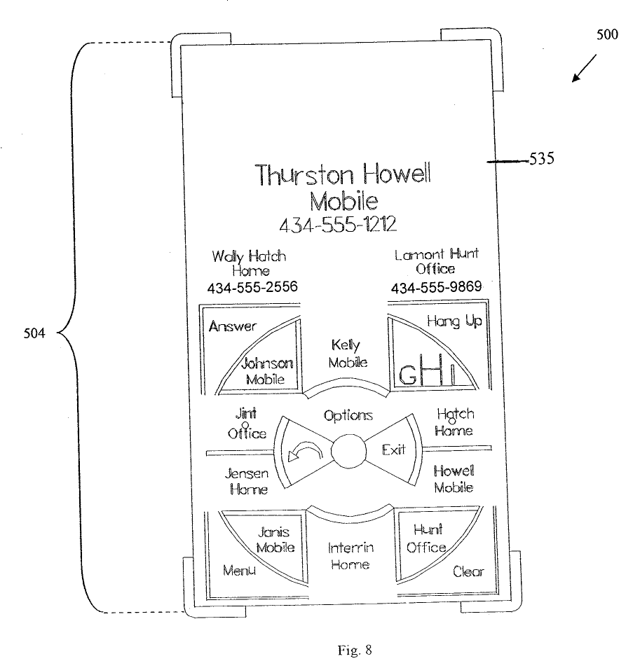

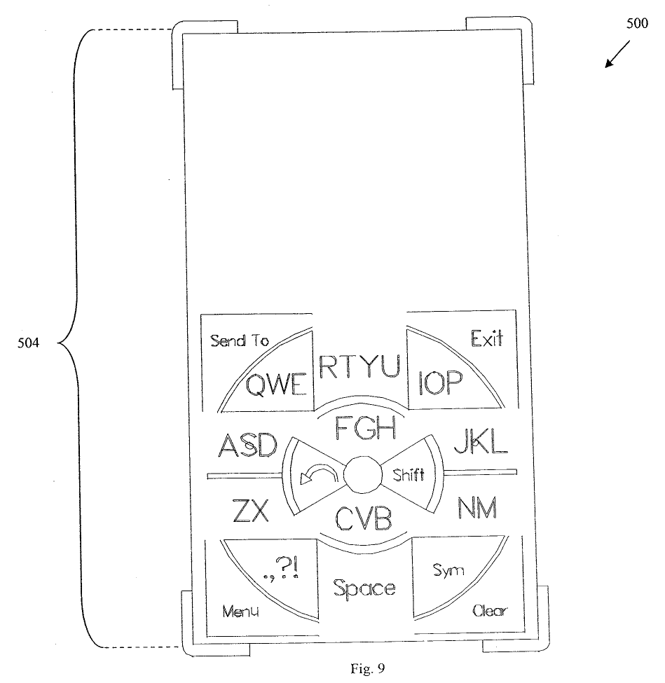

A display area 535 may be configured to display above the key pad area 503, or alternatively, a display area may be configured encompassing substantially the entire surface area including the keypad area 503, such as shown in relation to FIG. 7B and FIG. 8, for example, and denoted by reference numeral 504. Either a full display such as 504 or a partial display such as 535 of FIG. 5C may be employed with any embodiment herein, as applications warrant. In some embodiments, one or more of the “keys” 550a-550d, 555a-555d, 560a-560d, 570a, 570b, 575a, 575b, 580a, 580b may be permanently labeled with indicia related to the “key's” function.

The display area 535 and/or 504 may be any suitable display technology such as liquid crystal display (LCD). When the display area is configured to encompass substantially the entire surface area, as denoted by reference numeral 504, the tactile delineators (or a subset thereof) 505a-d, 507a-507d, 510a, 510b, 515a, 515b, 520a, 520b should be constructed of transparent material so that a displayed image (i.e, text, icons, graphics, images, colors, shading, and the like) beneath the tactile delineators 505a-d, 507a-507d, 510a, 510b, 515a, 515b, 520a, 520b can be seen and viewed by a user.

Preferably, the “keys” 550a-550d, 555a-555d, 560a-560d, 570a, 570b, 575a, 575b, 580a, 580b may be dynamically labeled according to the current application or feature, and may be dynamically altered as a user navigates or touches a particular “key”. The dynamic labeling may be achieved by software and/or hardware, either local to the hand held device, or altered by a remote software application in electronic communication with the hand held device. An application in conjunction with appropriate display controllers may provide visual textual or symbolic labels including shading or coloring to any of the “keys” 550a-550d, 555a-555d, 560a-560d, 570a, 570b, 575a, 575b, 580a, 580b.

The tactile delineators 510a, 510b, 515a, 515b form a circular discontinuous inner thumb guide rim, while the curved portion of tactile delineators 507a-507d forms a circular discontinuous outer thumb guide rim. Taken together, the inner and outer discontinuous thumb guide rims may form a circular thumb guide for guiding thumb motion, the motion and thumb guide, jointly denoted by reference numeral 572. Thumb motion may be in clockwise or counterclockwise directions, and any of the thumb guides or “keys” herein may be configured to respond to tactile pressure input such as resistive touch screen technology, or to respond to input from capacitive touch screen technology. The input may be a result of input from a user's finger and/or thumb, and perhaps even an inanimate object such as a pencil, pen, stylus, or the like, in the thumb guide and/or any “key” 550a-550d, 555a-555d, 560a-560d, 570a, 570b, 575a, 575b, 580a, 580b.

Also, the tactile delineators 510a, 510b, 515a, 515b may form a second thumb guide (which may have a circular outer discontinuous rim) in conjunction with the center key 530. The motion of a thumb within the second thumb guide is denoted jointly by reference numeral 577. So, the second thumb guide 577 may be configured to be within an outer thumb guide 572. Second thumb guide 577 and outer thumb guide 572 may be concentric thumb guides, one configured inside the other.

Further, FIGS. 5A-5D show a plurality of tactile positioning humps 520a, 520b to aid a user in recognizing a thumb position by feel at the three o'clock and nine o'clock positions, and also aid in informing the user where the thumb may be “resting” in relation to adjacent key pairs, i.e., pair 560a and 560b, and pair 560c and 560d. Moreover, a plurality of dimples may be provided, perhaps one for each “key,” such as dimples 525a, 525b, to give a tactile orientation of where the center of any particularly “key” may be located.

Two user operational modes associated with “key” operation are “rest,” which is a “preview” function so that a user may ascertain what is associated with a particular “key.” The “rest” function may cause an expansion or an “explosion” of information in the display area 535, or a portion thereof, depending on the function assigned to the “key” being “rested” upon. The other function is a “grab” function whereby a user fully engages a “key” by depressing the “key” with a greater force than when employing a “rest.” The “grab” function may cause a selection and execution of the function as previewed by the “rest” function.

In any embodiment herein, an audible feedback function may be provided to audibly speak a current selection where user's thumb or finger may be “resting.” For example, if the user has navigated to a function whereby the “keys” 550a-550d, 555a-555d, 560a-560d, 570a, 570b, 575a, 575b, 580a, 580b have been dynamically populated with a call list around one or more of the thumb guides 577, 572, for example, as a user may “rest” the thumb momentarily on a “key” to hear what is assigned to that particular “key.” The audible feedback may be automatically provided by text to speech conversion hardware/software, or the audible feedback may be a pre-recorded and pre-assigned voice of the user. This feature is particularly useful in low light situations and/or for visually impaired users. A user may then make a selection by pressing “fully” on the desired “key” (“grab”) to continue navigation to a new layer of selections (which may cause new dynamically assigned options for one or more of the “keys”) and/or to activate a feature assigned to the “grabbed” “key.”

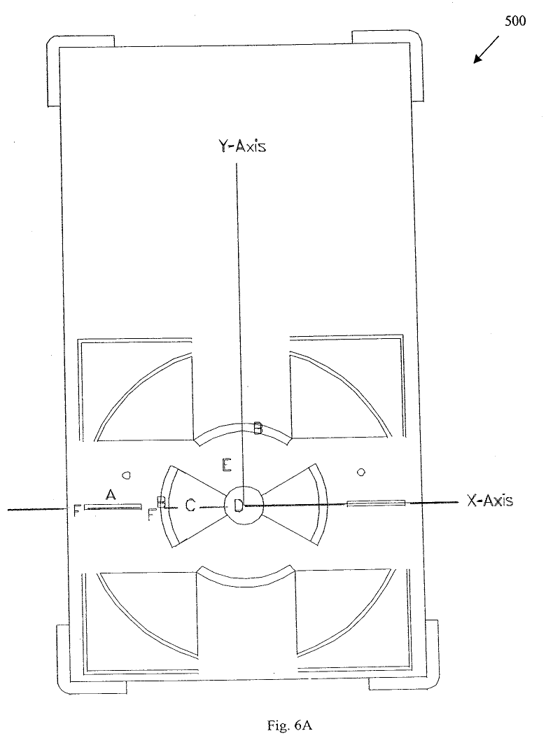

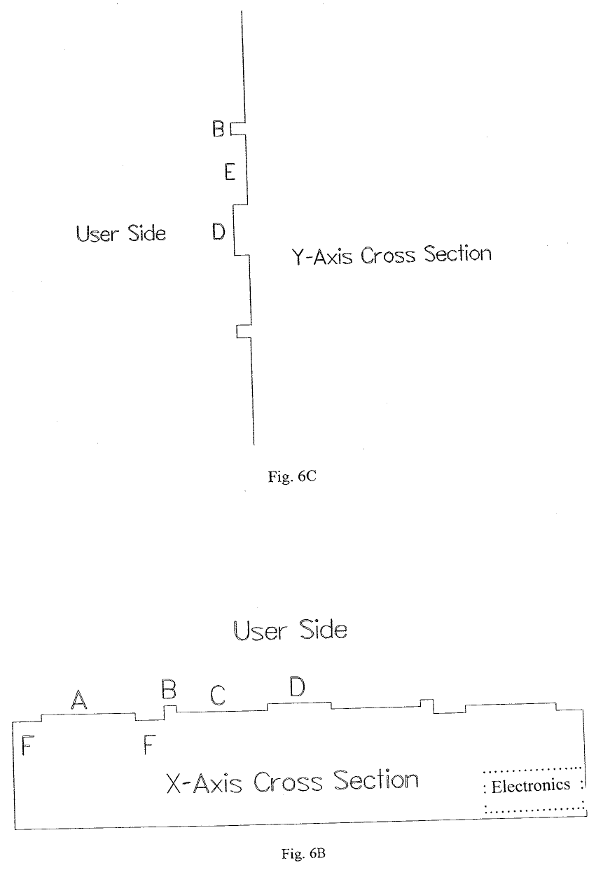

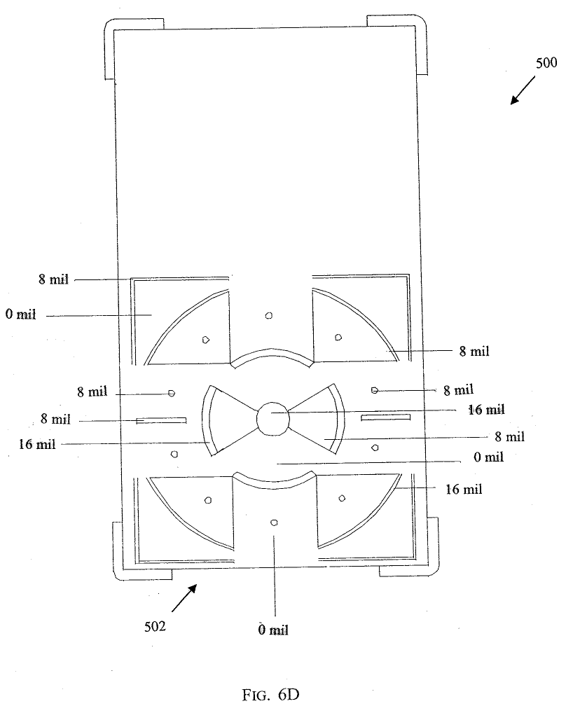

FIGS. 6A-6D are illustrations of the user interface of FIGS. 5A-5D showing certain exemplary relative dimensional information of the tactile delineators and certain keys. FIG. 6A shows an X-axis and a Y-axis for which information along these axes are provided in FIGS. 6B and 6C at points labeled “A,” “B,” “C,” “D,” and “E”. FIG. 6D shows exemplary dimensional information in mils (1 mil=0.001 inches), but may vary. The dimensional information may be viewed relative to the areas denoted by 0 mils. FIG. 6B also shows electronics that may be present with the user interface and/or hand held device to provide power, communications, processors, memory, software components, display drivers, input/output control, and the like. The electronics may be considered provided in any embodiment herein.

FIG. 7A is an illustration of an embodiment of a user interface configured according to principles of the invention. The illustration shows that once a user has navigated to a specific function, in this case to a music store, candidate music selections may be populated. Assuming that a users thumb is “resting” on the “key” labeled “Boston” (at about the 11 o'clock position), an “explosion” of information may be viewed in the display area 535. Moreover, options may be associated with keys 550a and 550b by presenting the options above the keys 550a, 550b in the display area 535, in this example, AC/DC “Back in Black” and Bruce Springsteen “Born in the USA.”

Alternatively, or in combination, since the entire surface of the user interface 500 may be touch sensitive, a user may navigate by also choosing a selection as presented in the display area 535. Moreover, the “rest” and “grab” functions may be operative in any portion of the display area 535, when the display area 535 is configured as a touch screen.

FIG. 7B is an illustration of an embodiment of a user interface configured according to principles of the invention. In this example, the entire user interface is configured as a display area, designated by reference numeral 504. FIG. 7B shows that the entire surface may present an image. Alternatively, when a user chooses to forego display operations, perhaps temporarily, such as when dialing “blind” or when no light is desired to be emitted by the display (for dark situations like theaters). However, the tactile delineators 505a-d, 507a-507d, 510a, 510b, 515a, 515b, 520a, 520b can still provide user guidance for dialing and operational control, even when the display area, including “keys” 550a-550d, 555a-555d, 560a-560d, 570a, 570b, 575a, 575b, 580a, 580b display indicia has been deactivated.

The touch screen technology employed in the embodiments hereinto may involve at least two forms of interaction with the application device. The first form may be referred to as “rest”, which is, as the phrase implies, simply resting a user finger on the touch sensitive surface of the device. The “rest” of a finger or thumb on a touch screen may be recognized by a resistant touch screen. There may be several techniques to achieve touch screen functionality. However, one way may include a resistant touch screen that may involve a layer of glass or plastic on the hardware side (lower side) of the device, two layers of ITO (Indium Tin Oxide) with a slight separation between the layers and then a layer of plastic on the top, user side. When a user touches the device's top surface, the two layers of ITO make contact and an exact X-Y axis provides a location of the touch. This determination may include a percentage calculation to determine that a finger/thumb/stylus is currently resting substantially on a key or a certain portion of a key. For example, this may be accomplished by calculating the weighted amount of presence of a finger/thumb/stylus on one key versus a neighboring key with the greater presence resulting in one key being deemed the current position where a “rest” or “grab” should occur. Moreover, this same technique may determine what portion of a “key” a finger/thumb/stylus may be positioned giving a biased location, thus permitting one “key” to provide multiple selections, based on a determined bias.

Based on the known X-Y location, an appropriate function may be displayed through “exploding software” (the function where the finger is currently resting may be displayed (“exploded”)) on the display 535 of the device. As a finger, thumb, or stylus is moved about the touch screen, new displays and options may be dynamically updated, including new indicia on one or more “keys.”

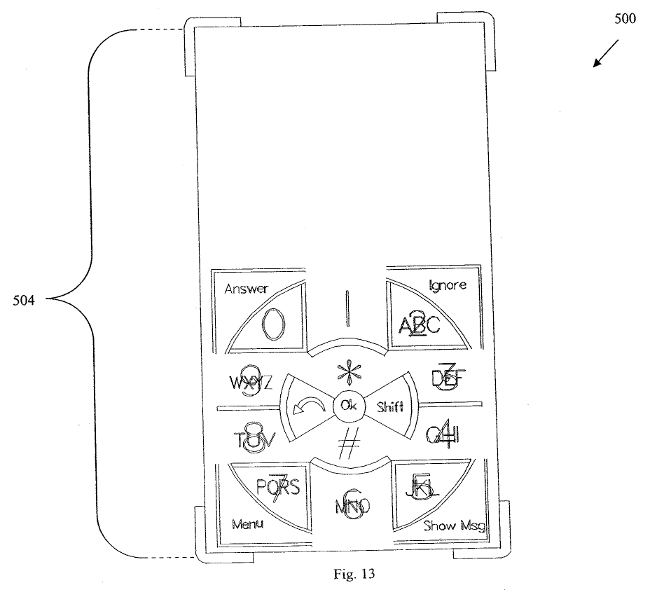

An example is now given with reference to FIG. 8, which shows an embodiment of the user interface configured according to principles of the invention and displaying a dial list. FIG. 8 may be viewed in conjunction with FIG. 12, to provide some added orientation. The illustration of FIG. 8 should be understood as having been produced by the user first going through the alphabet to the “4” key (GHI) (FIG. 12) and depressing that key twice to select “H” because “H” is the second letter on the “4” key (and which is the reason that the letter “H” is larger on the keypad in FIG. 8). Or if the user would rather directly depress the “H” key without depressing the “4” key multiple times, the user may touch the center of that key, the “dimple,” and the letter “H” may be immediately displayed. The display area 535 and “key” indicia may have been dynamically revised to present new call list information based on the “H” selection, i.e., several names beginning with “H,” “J” and “K” (names following the “H” names). The large “H” is assigned to “starting position” key “3,” i.e., the one o'clock position, with the list filled in around the clock face layout. The “starting position” may be arbitrary and may be assigned to another key, but this assignment should be consistent in any particular application for the user's benefit. The user has then subsequently moved their finger/thumb in a circular pattern in the thumb guide 570 stopping and “Resting” on the entry “Thurston Howell” (equivalent to key “9” of FIG. 12), which is why “Thurston Howell” information is “exploded” on the display area 535. To make a call to Thurston Howell, the user may depress that very same key, i.e., the “9” key of FIG. 12.

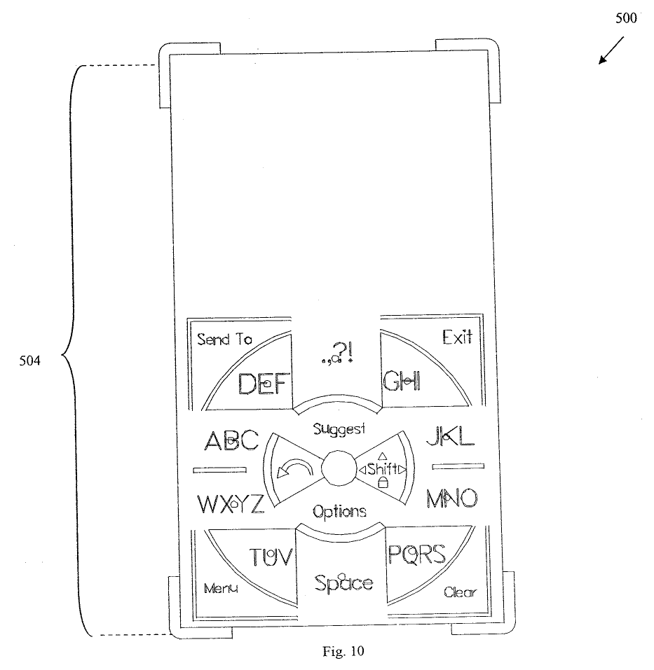

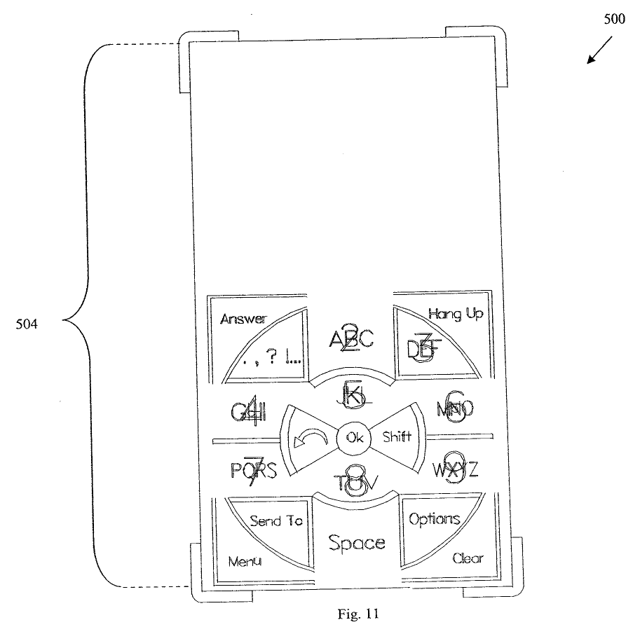

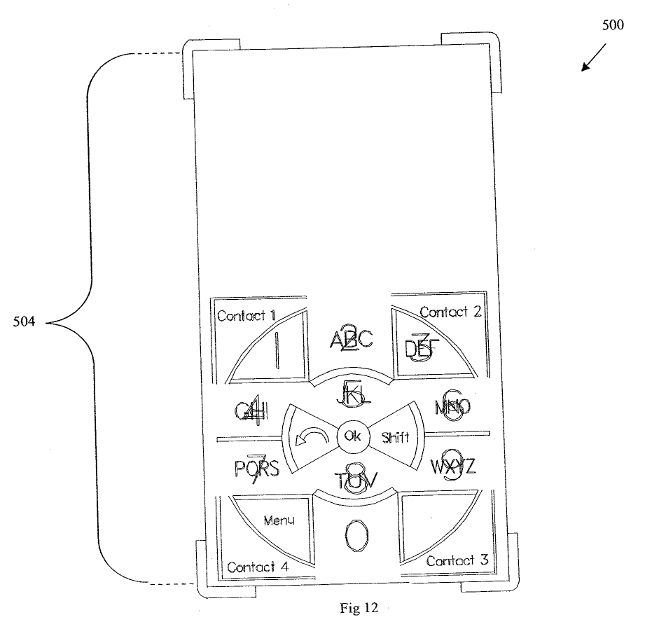

FIGS. 9, 10, 11, 12 and 13 are each embodiments of a user interface configured according to principles of the invention. Each of these layouts and associated indicia may be dynamically produced as applications warrant, perhaps under user choice. FIG. 9 shows a “new text” layout which shows exemplary “key” indicia assignments, as shown. FIG. 10 shows a traditional “QWERTY” style layout and exemplary “key” indicia assignments. FIG. 11 shows a traditional 3×4 matrix layout (i.e., mimicking traditional dial pads) and exemplary “key” indicia assignments for a text mode. FIG. 12 is a traditional dial mode layout with exemplary “key” indicia assignments. FIG. 13 is a clock layout in dial mode with exemplary “key” indicia assignments.

Amidst any phone call, in the mp3 mode or in a camera mode, the dial area, and especially the thumb guides, may be either a volume control or zoom operation, respectively. Furthermore, since the entire surface of the device may be a touch screen, the ability to touch anywhere on the device provides for “drag & drop” functions so that a user can select features and “drag” them to other portions of the display area to achieve advanced functional operations.

In alternate embodiments, key depressions may be audibly confirmed by audio output via a speaker controlled by onboard electronics within the hand held device. The audible output may be selectively alterable in tone or intensity for user preferences.

In the embodiments herein, since an X-Y coordinate system is provided with the touch screen technology to detect placement of a thumb or finger (or stylus) with a high degree of accuracy, a user's finger or thumb may be used to select a feature by moving the thumb or finger to one edge of a “key,” or in the center or the “key.” The X-Y scanning may discern that the user has biased the thumb or finger to one side or the middle of a “key” and provide options on the display area according to the biased location; and if the “key” is “grabbed” (selected) the feature or option associated with the finger/thumb placement with bias may be performed. For example, dial by name may be configured to detect that a thumb or finger is biased to a first side of a “key,” or in the middle of the key, or to a second side the key, and because of the bias determination, a selection as to which of three letters assigned to that key may be selected due to the bias determination (e.g., left, middle or right letter). In this way, a letter of three letters on the “key” may be selected with one click (i.e., one action), taking into account the bias of the finger or thumb. The bias determination may include ascertaining and calculating the percentage of finger/thumb/stylus placement on a region of a “key,” and based upon the calculation, a determination of which “key” is being touched and which portion of the “key” is biased. A selection input may be accepted based upon a determination of a sufficient force on the “key” to cause activation of an option associated with the “key,” and based on a bias determination on the “key.”

Below are exemplary steps and substeps of an embodiment of a process for using or providing a user interface constructed according to principles of the invention, the process may include all or a subset of the following steps and sub-steps:
Provide one or more circular thumb guides which may be concentric to one another, the one or more thumb guides comprising a plurality of keys configured to receive dynamically assignable indicia.
Configuring the plurality of keys so that at least a subset of the plurality of keys includes a first thumb guide rim to configure an outer thumb guide, and providing another subset of the plurality of keys that includes a second thumb guide rim to configure an inner thumb guide. The two subsets may or may not be the same.
Configuring one or more tactile features to the one or more keys.
Providing at least one center key within at least one inner thumb guide.
Providing a user interface including a touch sensitive surface and electronics configured to detect a position of a user finger, user thumb, or a stylus. Configuring the touch sensitive surface to detect the position in relation to the plurality of keys. Configuring the touch sensitive screen to detect a user selection relative to the plurality of keys, or a location on the touch sensitive surface.
Configuring a display area displaying text and/or images proximate a keypad area that includes the plurality of keys.
Configuring a second display area for displaying text and/or images beneath the tactile features and/or the plurality of keys.
Dynamically altering images or text on one or both display areas based on a position of a finger, thumb or stylus associates with a user. The altering may include changing indicia assigned to one or more of the plurality of keys.
Configuring a hand held device to utilize the user interface.
Providing supporting power, hardware, electronics, communications, computer processing, software components to control and receive information from the user interface, and to coordinate application features associated with the display area(s) and selections originating or associated with the user interface.
Providing an X-Y scan function to detect a location of a user thumb/finger/stylus on the surface of the touch screen. Calculating the position in relation to the plurality of keys. Calculating a bias on one of the plurality of keys for the finger/thumb/stylus using the calculated position.
Receiving an input based on a “rest” of the finger/thumb/stylus.
Processing a selection based on an input determined to be a “grab” caused by the finger/thumb/stylus pressing action.
Providing a “drag” operation on the display area(s) to logically move information from one location to another location on the display. The “drag” operation including moving a choice from one key of the plurality of keys to another location on the display area(s) causing a feature to be processed.
Providing audible feedback to audibly announce a feature or function associated with a location on the touch sensitive screen, including any of the plurality of keys. Configuring the audible feedback to announce based upon a location of the user's finger/thumb/stylus.
Providing non-continuous thumb guide rim or rims.
Providing indicia for the plurality of keys to mimic at least one of: a traditional circular clock layout, a QWERTY layout, a 3×4 layout, and a pre-determined layout, which may be user defined.

### Non-Limiting Exemplary Comparison of Prior Operations and Tracr:

On most hand-held devices prior to tracr, that provided texting functions, texting was a post-production operation therefore making the device somewhat handicapped in regards to “key” location. In prior devices, when texting, the user is typically forced to cross over keys, mainly the 2 (ABC), 5 (JKL) and the 8 (TUV), and is also forced to input their keys in a very unnatural manner since the letters begin in the middle of the device and wrap to the right, skip back to the far left and wrap back to the right again, etc. Since two thumbs are commonly used when texting, the user does not have the surface area to prevent misdials and their own fingers impede their vision in the crossover strokes. In contrast, since tracr is touch screen, the device may be manipulated at the startup point to text in a number of different ways, a) typical 3×4 matrix which is what is found on most devices (to reduce the learning curve of a new method to text), b) around the tracr wheel with a very practical, alphabetical thought to every location of the letters and c) QWERTY layout.

In this example, a comparison is provided of two different ways to text; i) typical cell phone device, and, ii) tracr. In both examples a short message is being sent “What time are you coming?”

First, using a typical cell phone, prior to the invention:
1. First locate the utility (usually located on the right or left toggle button) and press it.
2. Press “Create Message” in the new menu.
3. Press “New Short Message” in the new menu.
4. Now begin inputting the message, starting with the “W” in “What” located in the “9” key (pressed 1 time).
5. Continue the sequence found above until all of the letters and spaces have been inputted.
6. From time to time (but not in this phrase), the system will offer a word that it already has in its dictionary. To choose this word, the user may once again change keys and depress the right arrow button found above the “2” key.
7. Finally depress the “1” key and locate the “?” with the arrows (found within the circle above the “2”) and press the central circle found within this same circle.
8. Depress the “Send To” toggle button located at the top of the keypad.
   Now, exemplary steps when using tracr:

1. Rotate your finger around the circular keypad until “Text” appears in the display

2. Next locate the “W” found with the “9” key. Depress this key just to the left of the dimple (bias detection) and the letter “W” appears. As the user drags, the user may notice words appearing on the display area. Once the word “what” is found depress that “key.”

3. Do this same task with each letter or, if the word is not shown, simply depress the associated key once or multiple times until the appropriate letter is shown.

4. Once the phrase is complete, depress the “?” located where the “2” used to be. Once depressed, again the user may have the option of either depressing it twice for “?” or by depressing it and dragging a finger to the left (or right) for the “?” symbol.

5. Finally depress the “Send To” located in the center.

The prior devices before the invention requires the user to “jump around” on the keypad while paying attention to the display, to make sure that the correct letter was depressed (again, forcing an up down movement of the head). However, with tracr, the same task is accomplished from one circular touch screen keypad. By depressing the key and dragging along the thumb guide, the device shows words that are in a text dictionary. Each time a user creates or sends a text message, or otherwise enters text in certain applications, the device or associated system may update the text dictionary. The end result is a much faster, more efficient process with tracr.

The examples given above are merely illustrative and are not meant to be an exhaustive list of all possible embodiments, applications or modifications of the invention. Thus, various modifications and variations of the described methods and devices of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention which are obvious to those skilled in orthopedics or related fields are intended to be within the scope of the appended claims.

The disclosures of any patents, references and publications cited above are expressly incorporated by reference in their entireties to the same extent as if each were incorporated by reference individually.

What is claimed is:

1. An apparatus for a hand held electronic device, comprising a plurality of touch sensitive keys arranged contiguously with an outermost first subset of the plurality of touch sensitive keys symmetrically forming four corners of a substantially rectangular touch pad, a second subset of the keys arranged circularly within the outermost first subset of the plurality of touch sensitive keys, and a third subset of the plurality of touch sensitive keys arranged symmetrically within the second subset of the plurality of touch sensitive keys, wherein each of the plurality of touch sensitive keys is configured to receive user input to operate at least one feature associated with the hand held electronic device.

2. The apparatus of claim 1, wherein the plurality of touch sensitive keys are constructed as a monolithic touch sensitive surface.

3. The apparatus of claim 2, wherein each subset of plurality of touch sensitive keys is delineated from another subset of the plurality of touch sensitive keys by a tactile feature.

4. The apparatus of claim 1, further comprising a tactile ridge separating the outermost first subset of the plurality of touch sensitive keys from the second subset of the plurality of touch sensitive keys, forming a circular guide around the second subset of plurality of touch sensitive keys.

5. The apparatus of claim 4, wherein the circular guide is a thumb guide.

6. The apparatus of claim 1, further comprising a tactile ridge separating the second subset of the plurality of touch sensitive keys from the third subset of the plurality of touch sensitive keys, and forming a circular guide around the second subset of plurality of touch sensitive keys and the third subset of the plurality of touch sensitive keys.

7. The apparatus of claim 1, further comprising a fourth subset of the plurality of touch sensitive keys located within the third subset of the plurality of touch sensitive keys.

8. The apparatus of claim 7, wherein the fourth subset of the plurality of touch sensitive keys comprises a single key having a tactile feature to locate the single key.

9. The apparatus of claim 1, wherein at least a portion of the third subset of the plurality of touch sensitive keys have a tactile feature to aid in identifying the at least a portion of the third subset of plurality of touch sensitive keys.

10. The apparatus of claim 9, wherein the at least a portion of the third set of plurality of touch sensitive keys comprise alternating keys within the third subset of plurality of touch sensitive keys.

11. The apparatus of claim 1, wherein the second subset of the plurality of touch sensitive keys arranged circularly has twelve keys.

12. The apparatus of claim 1 1, wherein the second subset of the plurality of touch sensitive keys comprises twelve keys and are configured to mimic an analog clock layout, with the second subset of the plurality of touch sensitive keys located at the 3 o'clock, 6 o'clock, 9 o'clock and 12 o'clock positions having a tactile characteristic different from the other second subset of the plurality of touch sensitive keys.

13. The apparatus of claim 12, wherein the tactile characteristic comprises a concave depression.

14. The apparatus of claim 1, wherein the second subset of the plurality of touch sensitive keys comprise twelve keys and are configured to mimic an analog clock layout, with each of the twelve keys representing corresponding telephonic dial pad digits, 1-9, 0, *, #, respectively.

15. The apparatus of claim 14, wherein one of the second subset of the plurality of touch sensitive keys located at the 10 o'clock position being the telephonic key known as “0,” and one of the second subset of the keys located at the 11 o'clock position being the telephonic key known as “*”, and one of the second subset of the keys located at the 12 o'clock position being the telephonic key known as “#”.

16. The apparatus of claim 1, further comprising a fourth subset of the keys located above the substantially rectangular touch pad.

17. An apparatus for a hand held electronic device, comprising a plurality of touch sensitive keys arranged contiguously with an outermost first subset of the plurality of touch sensitive keys symmetrically forming four corners of a substantially rectangular touch pad, a second subset of the keys arranged circularly within the outermost first subset of the plurality of touch sensitive keys, and a third subset of the plurality of touch sensitive keys arranged symmetrically within the second subset of the plurality of touch sensitive keys, and a fourth subset of the plurality of touch sensitive keys located within the third subset of the plurality of touch sensitive keys, wherein each of the plurality of touch sensitive keys is configured to receive user input to operate at least one feature associated with the hand held electronic device and wherein the plurality of touch sensitive keys comprises a monolithic pad and each subset of keys is delineated from another subset by a tactile feature to distinguish each subset from another.

18. The apparatus of claim 17, wherein the plurality of touch sensitive keys are configured to distinguish a touch and a selection of one the touch sensitive keys.

19. The apparatus of claim 18, wherein the plurality of touch sensitive keys are configured to determine a bias on a particular key.

20. The apparatus of claim 17, further comprising a display configured to present an image at least under the plurality of keys, the image controllable to provide indicia for the plurality of keys.

21. The apparatus of claim 17, further comprising a display configured to present an image adjacent the plurality of keys for displaying text or images associated with functions selected by the activation of at least one of the plurality of keys.

22. A method for providing a user interface, the method comprising the steps of:
providing at least one circular thumb guide configured with at least one rim for guiding a digit of a user;
configuring a plurality of keys on a touch sensitive surface, wherein the plurality of keys configured to have indicia dynamically assigned, and wherein the at least one circular thumb guide is configured on at least a subset of the plurality of keys;
providing electronics to determine a position of the digit of a user in relation to the plurality of keys; and
processing a feature based on the determined position.

23. The method of claim 22, further comprising providing a display area and coordinating the display with the determined position of the digit of the user or a stylus.

24. The method of claim 23, wherein the step of providing a display area includes providing a display area at least one of: laterally adjacent the plurality of keys and beneath the plurality of keys.

25. The method of claim 24, wherein the step of providing a display area includes providing a liquid crystal display (LCD).

26. The method of claim 22, wherein the processing of a feature is based on one of a rest or a grab function.

27. The method of claim 22, further comprising providing a second circular thumb guide configured with at least one second rim.

28. The method of claim 27, wherein the at least one second rim is discontinuous along at least a part of the second circular thumb guide.

29. The method of claim 22, wherein the at least one rim is discontinuous along the at least one circular thumb guide.

30. The method of claim 22, further comprising dynamically assigning indicia to the plurality of keys.
